(19) United States
(12) Patent Application Publication
(10) Pub. No.: US 2025/0125379 A1
(43) Pub. Date: Apr. 17, 2025

(54) CARBON-ENCAPSULATED ALLOY CATALYST, PREPARATION METHOD THEREFOR AND USE THEREOF

(71) Applicant: Sinohykey Technology Guangzhou Co., LTD., Guangzhou (CN)

(72) Inventors: Dequan He, Guangzhou (CN); Mingquan Zhao, Guangzhou (CN); Zhixuan Yuan, Guangzhou (CN); Bei Xu, Guangzhou (CN); Shiwen Lu, Guangzhou (CN); Yunsong Yang, Guangzhou (CN); Siyu Ye, Guangzhou (CN); Yuquan Zou, Guangzhou (CN); Junke Tang, Guangzhou (CN)

(21) Appl. No.: 18/677,974

(22) Filed: May 30, 2024

(30) Foreign Application Priority Data
Oct. 13, 2023 (CN) 202311328041.9

(51) Int. Cl. H01M 4/92; H01M 4/86

(52) U.S. Cl. CPC H01M 4/923; H01M 4/8657; H01M 4/921; H01M 4/926

(57) ABSTRACT

A preparation method of a carbon-encapsulated alloy catalyst includes: S1, subjecting a catalyst to a heat treatment in a first reducing gas atmosphere to obtain a heat-treated catalyst, mixing the heat-treated catalyst with a carbonization compound, a ligand compound, a carbonization catalyst, and a solvent to obtain a mixture, subjecting the mixture to ultrasonic dispersion and stirring to obtain a first dispersion system, centrifuging and drying to obtain a powder; and S2, annealing the powder in a second reducing gas atmosphere to obtain an annealed powder, dispersing the annealed powder in an acid solution then heating and filtering to obtain a cake, and vacuum-drying the cake to obtain the carbon-encapsulated alloy catalyst, where the catalyst is a commercial platinum alloy catalyst or a platinum alloy catalyst prepared from a support and metal precursors.

### CROSS-REFERENCE TO RELATED APPLICATION

The present disclosure claims priority to Chinese Patent Application No. 202311328041.9 filed on Oct. 13, 2023, which is incorporated herein by reference in its entirety.

### TECHNICAL FIELD

The present disclosure belongs to the technical field of fuel cells, and specifically relates to a carbon-encapsulated alloy catalyst, a preparation method therefor and use thereof.

### BACKGROUND

The overuse of fossil fuels poses severe challenges to the energy and environment, and this problem is expected to be solved by the development of clean energy conversion technologies. Proton exchange membrane fuel cells (PEMFCs) can convert chemical energy directly into electric energy by electrochemically oxidizing a renewable fuel (such as hydrogen) at the anode and reducing oxygen into water at the cathode. Currently, the PEMFC technology undergoes extensive research and development due to its advantages such as high energy conversion efficiency, almost no pollution, and potential large-scale applications. Platinum is used to catalyze an oxygen reduction reaction (ORR) in most of commercial PEMFCs. However, due to slow kinetics of ORR, the catalytic activity of platinum for ORR is still several orders of magnitude lower than the catalytic activity of platinum for a hydrogen oxidation reaction (HOR) at the anode (S Guo, S Zhang, S Sun, Angew. Chem. Int. Ed. 2013, 52, 8526). Therefore, the large-scale promotion and application of fuel cells requires the development of an ORR catalyst with a low cost, a high activity, and good durability, thereby further reducing a catalyst cost.

Among many innovative approaches for preparing novel ORR catalysts, the alloying of Pt with a transition metal (Fe, Co, Ni, or the like) is widely recognized as a promising approach to improve the performance of a catalyst and reduce the consumption of platinum, thereby reducing a catalyst cost. Y Yoo, J M Yoo, et al. adjust a d-band center of Pt by introducing a transition metal to enhance the performance of ORR, thereby allowing an expected catalytic effect for ORR in a fuel cell (Y Yoo, J M Yoo, et al., J. Am. Chem. Soc. 2020, 142, 14190). However, compared with a Pt-based catalyst, an alloy catalyst has insufficient stability. The stability of an alloy catalyst needs to be further improved to allow large-scale commercial applications of the alloy catalyst in hydrogen fuel cells.

An alloy catalyst has insufficient stability mainly due to the following reasons: (1) The most common carbon support currently is Vulcan XC-72 produced by Cabot. This carbon support has many defect sites and a high oxygen content, which is conducive to increasing a platinum load, but will aggravate the carbon corrosion. The corrosion of the carbon support will aggravate the agglomeration and loss of an alloy. In addition, the presence of Pt will accelerate the corrosion of the carbon support, resulting in a decline in a life of a hydrogen fuel cell (Roen L M, Paik C H, JarviD. Electrochem Solid State Lett, 2004, 7 (1): A19). Luo Xuan et al. calcine a carbon support at different temperatures, and results show that after calcination, the stability of both the carbon support and a corresponding Pt-based catalyst is improved. In particular, after a catalyst produced by calcination at 2,100° C. is oxidized under a potential of 1.75 V for 10 min, an electrochemical active surface area (ECSA) of the catalyst can still retains 82.4%. However, after pristine catalyst is oxidized under a potential of 1.75 V for 10 min, an ECSA of the unmodified catalyst basically disappears completely (Luo Xuan, Hou Zhongjun, Ming Pingwen, et al. Chinese Journal of Catalysis, 2008 (04): 330-334). In addition, Chen M et al. deposit a metal precursor on a nitrogen/metal co-doped large-size graphene tube (NGT) and produce PtM (M: Co and Ni) alloy during a annealing process, which greatly improves the stability of the catalyst. After the PtM (M: Co and Ni) alloy loaded on a highly-graphitized graphene tube undergoes 20,000 potential cycles (0.6 V to 1.0 V vs. reversible hydrogen electrode (RHE)), 70% of ECSA of the PtM alloy can still be retained (Chen M, Sooyeon H, Li J, et al. Nanoscale, 2018:10.1039. C8NR05888A-). The increase of a graphitization degree can alleviate the carbon corrosion, and makes a surface of a carbon support chemically inert, but it is difficult to evenly disperse an alloy catalyst on a carbon support (Rong Junfeng, Zhao Hong, Wang Houpeng, et al. Beijing: CN114430049A, 2022 May 3). (2) During a membrane electrode assembly (MEA) durability test, a transition metal is easy to precipitate from an alloy, resulting in a sharp decrease in durability of a MEA (Wu Shouliang, Liu Jun, Zhang Xian, Wang Xinlei. Anhui Province: CN112615016A, 2021 Apr. 6). Recently, Li et al. carbonize an oleylamine ligand to produce a “catalyst armor” to protect internal Pt nanoparticles from being damaged and thus enhance the stability of a catalyst (Li Z, Yang D, Dong A, et al. Advanced Materials, 2022, 34:2202743). However, all the above studies involve treating a Pt/C catalyst with a low platinum load, and a too-high annealing temperature can easily damage the structure of a platinum alloy to reduce an activity of the platinum alloy. In addition, there are few studies on improving the stability of a platinum alloy catalyst with a high platinum load. Therefore, there is a need for a method to improve the stability of a alloy catalyst by tailoring defect and oxygen contents in the catalyst and mitigating the dissolution of an alloy.

### SUMMARY

The present disclosure provides a carbon-encapsulated alloy catalyst. a preparation method therefor, and use thereof. The carbon-encapsulated alloy catalyst prepared in the present disclosure has high stability, and can overcome the problem that the existing high-load alloy catalysts (platinum content: higher than or equal to 20%) have insufficient stability due to defects and a high oxygen content in a support and the problem that too-high annealing temperatures for the current carbon-encapsulated alloy catalysts will damage the structure of an alloy to reduce an activity of the alloy.

The present disclosure adopts the following technical solutions: A preparation method of a carbon-encapsulated alloy catalyst is provided, including the following steps:
S1, subjecting a catalyst to a heat treatment in a first reducing gas atmosphere to obtain a heat-treated catalyst, mixing the heat-treated catalyst with a carbonization compound, a ligand compound, a carbonization catalyst, and a solvent to obtain a mixture, subjecting the mixture to ultrasonic dispersion and stirring (making the carbonization compound, the ligand compound, and the carbonization catalyst uniformly adsorbed on a surface of the heat-treated catalyst through a coordination interaction) to obtain a first dispersion system, centrifuging the first dispersion system to obtain a precipitate, and drying the precipitate to obtain a powder; and
S2, annealing the powder in a second reducing gas atmosphere to obtain an annealed powder, dispersing the annealed powder in an acid solution to obtain a second dispersion system, subjecting the second dispersion system to heating and suction filtration to obtain a filter cake, and vacuum-drying the filter cake to obtain the carbon-encapsulated alloy catalyst,
where the catalyst is a commercial platinum alloy catalyst or a platinum alloy catalyst prepared from a support and a metal precursor.

In some embodiments, the first reducing gas atmosphere in the S1 and the second reducing gas atmosphere in the S2 independently includes at least one selected from the group consisting of a 5% hydrogen/argon mixed gas, a 5% carbon monoxide/helium mixed gas, and a 5% ammonia/nitrogen mixed gas. The content percentage of 5% refers to a volume proportion of a reducing gas in a total gas system.

In some embodiments, the commercial platinum alloy catalyst includes at least one selected from the group consisting of PtCo/C, PtCoNi/C, and PtNi/C.

In some embodiments, a platinum content in the commercial platinum alloy catalyst is higher than or equal to 20%.

In some embodiments, the support includes at least one selected from the group consisting of acetylene black, carbon black, a carbon nanotube, mesoporous carbon, graphene, a carbon nanowire, and a graphite fiber.

In some embodiments, the metal precursor includes at least one selected from the group consisting of chloroplatinic acid, platinum chloride, platinum acetylacetonate, cobalt acetylacetonate, cobalt chloride, nickel acetylacetonate, iron nitrate, and copper acetylacetonate.

In some embodiments, the metal precursor includes at least one selected from the group consisting of chloroplatinic acid, platinum chloride, and platinum acetylacetonate.

In some embodiments, the metal precursor further includes at least one selected from the group consisting of cobalt acetylacetonate, cobalt chloride, nickel acetylacetonate, iron nitrate, and copper acetylacetonate.

In the present disclosure, a preparation method of the platinum alloy catalyst prepared from the support and the metal precursor includes the following steps: ultrasonically dispersing the support in ethylene glycol for 30 min to 60 min to obtain a dispersion solution, adding the metal precursor to the dispersion solution to obtain a first mixture, and continuously stirring the first mixture for 12 h to 24 h to obtain a second mixture; heating the second mixture to 180° C. to 200° C., and allowing a reaction under reflux for 8 h to 10 h to obtain a reaction system; and cooling and centrifuging (or suction filtration is adopted instead of the centrifugation) the reaction system to obtain a solid, and vacuum-drying the solid to obtain the platinum alloy catalyst.

The carbonization compound in the present disclosure refers to a compound allowing the production of a carbon layer on a surface of a catalyst through a specified process and heat treatment.

In some embodiments, the carbonization compound includes at least one selected from the group consisting of malic acid, dopamine, polydopamine, oleylamine, glucose, and sucrose.

The ligand compound in the present disclosure refers to a compound capable of being decomposed to produce a gas to form a microporous structure in a carbon layer when the compound and the carbonization compound are used together to treat a catalyst.

In some embodiments, the ligand compound includes at least one selected from the group consisting of formic acid, thiourea, ammonia monohydrate, ammonium carbonate, and urea.

The carbonization catalyst in the present disclosure refers to a metal-based catalyst capable of catalyzing the carbonization of the carbonization compound to form a carbon layer at a low heat-treatment temperature.

In some embodiments, the carbonization catalyst includes at least one selected from the group consisting of cobalt chloride, cobalt nitrate, nickel chloride, and nickel nitrate.

In some embodiments, in the S1, the solvent is an alcohol or an alcohol aqueous solution; and/or the solvent is added at an amount of 8 mL to 15 mL.

In some embodiments, the heat-treated commercial platinum alloy catalyst, the carbonization compound, the ligand compound, and the carbonization catalyst are in a mass ratio of 1: (1-10): (0.2-2): (0.1-1). It can be understood that the mass ratio of the heat-treated commercial platinum alloy catalyst, the carbonization compound, the ligand compound, and the carbonization catalyst includes, but is not limited to, 1:1:0.2:0.1, 1:10:2:1, 1:3:1:0.4, 1:2:0.5:0.5, 1:8:1:0.1, 1:5:1.5:1, and 1:5:1:1.

In some embodiments, the metal precursor, the support, the carbonization compound, the ligand compound, and the carbonization catalyst are in a mass ratio of 1:(0.5-1): (0.8-8): (0.17-17): (0.09-0.9). It can be understood that the mass ratio of the metal precursor, the support, the carbonization compound, the ligand compound, and the carbonization catalyst includes, but is not limited to, 1:0.5:0.8:0.17:0.09, 1:1:8:17:0.9, 1:0.6:4:1:0.5, 1:0.8:5:10:0.3, 1:0.5:8:15:0.9, and 1:1:1:1:0.9.

In some embodiments, the heat treatment in the S1 is conducted at 200° C. to 400° C. for 1 h to 2 h.

In some embodiments, the ultrasonic dispersion in the S1 is conducted for 10 min to 30 min.

In some embodiments, the stirring in the S1 is conducted for 12 h to 24 h.

In some embodiments, the annealing in the S2 is conducted at 400° C. to 500° C. for 2 h to 4 h.

In some embodiments, a concentration of the acid solution in the S2 is 1 M to 1.5 M. In some embodiments, the acid solution can be selected from the group consisting of strong acid solutions such as HCl, sulfuric acid, and nitric acid in the art.

In some embodiments, the heating in the S2 is as follows: heating the second dispersion system to a temperature of 70° C. to 80° C., and holding the temperature for 2 h to 12 h.

In some embodiments, the vacuum-drying in the S2 is conducted at 60° C. for 4 h to 6 h.

In the present disclosure, an alloy catalyst is first subjected to a heat treatment at a specified temperature in a reducing gas to improve the defects and oxygen content in a support of the alloy catalyst and increase a graphitization degree of the support to alleviate the carbon corrosion. Then, the catalyst is post-treated by annealing at a specified temperature under a combined action of a carbonization compound, a ligand compound, and a carbonization catalyst, in order to obtain the carbon-encapsulated platinum alloy catalyst, thereby alleviating the dissolution of the alloy and improving the stability of the alloy. In the present disclosure, the corrosion resistance of a support in a catalyst with a high platinum content is improved through a treatment with a reducing gas, thus reducing the agglomeration and loss of an alloy catalyst. In addition, the use of a carbonization catalyst reduces a treatment temperature for producing a carbon-encapsulated alloy catalyst, which can effectively avoid the problem that the destruction of a platinum alloy structure caused by a too-high annealing temperature reduces an electrocatalytic activity of the carbon-encapsulated platinum alloy catalyst in the art. Therefore, the present disclosure can effectively improve the electrocatalytic stability of a platinum alloy catalyst for ORR without destroying the structure of a platinum alloy and reducing an electrocatalytic activity for ORR.

The present disclosure also provides a carbon-encapsulated alloy catalyst prepared by the preparation method of a carbon-encapsulated alloy catalyst described above.

The present disclosure also provides a use of the carbon-encapsulated alloy catalyst in preparation of a fuel cell.

Compared with the prior art, the present disclosure has the following beneficial effects:

The carbon-encapsulated alloy catalyst prepared in the present disclosure has advantages such as high stability and high catalytic activity. In the carbon-encapsulated alloy catalyst, defects and an oxygen content in a support are improved and a graphitization degree of the support is increased, thus alleviating carbon corrosion.

### BRIEF DESCRIPTION OF THE DRAWINGS

FIG. 1 shows a transmission electron microscopy (TEM) image of the PtCo/C catalyst (Pt content: 28%) adopted in the present disclosure;

FIG. 2 shows a TEM image of the carbon-encapsulated PtCo/C catalyst prepared in Example 1 of the present disclosure;

FIG. 3 shows a TEM image of the carbon-encapsulated PtCo/C catalyst prepared in Comparative Example 1 of the present disclosure;

FIG. 4 shows a TEM image of the carbon-encapsulated PtCo/C catalyst prepared in Comparative Example 2 of the present disclosure;

FIG. 5 shows cyclic voltammetry (CV) curves of the carbon-encapsulated PtCo/C catalysts prepared in Example 1 and Comparative Examples 1 and 2 of the present disclosure;

FIG. 6 shows linear sweep voltammetry (LSV) curves of the carbon-encapsulated PtCo/C catalysts prepared in Example 1 and Comparative Examples 1 and 2 of the present disclosure;

FIG. 7 shows CV curves of the carbon-encapsulated PtCo/C catalysts prepared in Examples 2 to 4 and Comparative Examples 11 and 12 of the present disclosure;

FIG. 8 shows LSV curves of the carbon-encapsulated PtCo/C catalysts prepared in Examples 2 to 4 and Comparative Examples 11 and 12 of the present disclosure;

FIG. 9 shows CV curves of the carbon-encapsulated PtCo/C catalysts prepared in Example 1 and Comparative Examples 6 to 10 of the present disclosure;

FIG. 10 shows LSV curves of the carbon-encapsulated PtCo/C catalysts prepared in Example 1 and Comparative Examples 6 to 10 of the present disclosure;

FIG. 11 shows CV curves of the carbon-encapsulated PtCo/C catalysts prepared in Example 5 and Comparative Examples 3 to 5 of the present disclosure;

FIG. 12 shows LSV curves of the carbon-encapsulated PtCo/C catalysts prepared in Example 5 and Comparative Examples 3 to 5 of the present disclosure;

FIG. 13 shows polarization current curves of a commercial PtCo/C catalyst after an accelerated durability test; and

FIG. 14 shows polarization current curves of the carbon-encapsulated PtCo/C catalyst prepared in Example 1 of the present disclosure after an accelerated durability test.

### DETAILED DESCRIPTION OF THE EMBODIMENTS

The technical solutions in the embodiments of the present disclosure are clearly and completely described below with reference to the examples of the present disclosure. Apparently, the described examples are merely some rather than all of the examples of the present disclosure. All other embodiments obtained by a person of ordinary skill in the art based on the embodiments of the present disclosure without creative efforts shall fall within the protection scope of the present disclosure.

In the examples and comparative examples, unless otherwise specified, the experimental methods used are conventional, and the materials and reagents used are commercially available.

### Example 1

S1, A commercial PtCo/C catalyst (Pt content: 28%) was taken and placed in a crucible, and then the crucible was placed in a 5% hydrogen/argon mixed gas atmosphere at 400° C. for 2 h to obtain a heat-treated PtCo/C catalyst; 50 mg of the heat-treated PtCo/C catalyst was taken and placed in a flask, then 50 mg of urea, 200 μL of oleylamine, 20 mg of cobalt nitrate, and 10 mL of an isopropanol/water (in a volume ratio of 50:50) mixture were added to the flask, and an ultrasonic treatment was conducted for 10 min to obtain a mixed solution; and the mixed solution was placed in a water bath at 25° C. and stirred for 16 h, and then centrifuged (10,000 r.p.m., 5 min) to obtain a precipitate, and the precipitate was collected and vacuum-dried at 60° C. for 6 h to obtain a powder.

S2, The powder was placed in a 5% hydrogen/argon mixed gas atmosphere at 400° C. for 2 h, dispersed in 1 M HCl, heated to 70° C. and kept at this temperature for 2 h, and subjected to suction filtration to obtain a filter cake, and the filter cake was vacuum-dried at 60° C. for 6 h to obtain a carbon-encapsulated PtCo/C catalyst.

In this example, the ligand compound adopted can be replaced by any one selected from the group consisting of formic acid, thiourea, ammonia monohydrate, and ammonium carbonate; the carbonization compound adopted can be replaced by any one selected from the group consisting of malic acid, dopamine, polydopamine, glucose, and sucrose; and the carbonization catalyst adopted can be replaced by any one selected from the group consisting of cobalt chloride, nickel chloride, and nickel nitrate.

### Example 2

S1, A commercial PtCo/C catalyst (Pt content: 28%) was taken and placed in a crucible, and then the crucible was placed in a 5% hydrogen/argon mixed gas atmosphere at 400° C. for 2 h to obtain a heat-treated PtCo/C catalyst; 50 mg of the heat-treated PtCo/C catalyst was taken and placed in a flask, then 50 mg of thiourea, 100 mg of oleylamine, 20 mg of cobalt nitrate, and 10 mL of an isopropanol/water (in a volume ratio of 50:50) mixture were added to the flask, and an ultrasonic treatment was conducted for 10 min to obtain a mixed solution; and the mixed solution was placed in a water bath at 25° C. and stirred for 16 h, and then centrifuged (10,000 r.p.m., 5 min) to obtain a precipitate, and the precipitate was collected and vacuum-dried at 60° C. for 6 h to obtain a powder.

S2, The powder was placed in a 5% hydrogen/argon mixed gas atmosphere at 400° C. for 2 h, dispersed in 1 M HCl, heated to 70° C. and kept at this temperature for 2 h, and subjected to suction filtration to obtain a filter cake, and the filter cake was vacuum-dried at 60° C. for 6 h to obtain a carbon-encapsulated PtCo/C catalyst.

In this example, the ligand compound adopted can be replaced by any one selected from the group consisting of urea, formic acid, ammonia monohydrate, and ammonium carbonate; the carbonization compound adopted can be replaced by any one selected from the group consisting of malic acid, dopamine, polydopamine, glucose, and sucrose; and the carbonization catalyst adopted can be replaced by any one selected from the group consisting of cobalt chloride, nickel chloride, and nickel nitrate.

### Example 3

S1, A commercial PtCo/C catalyst (Pt content: 28%) was taken and placed in a crucible, and then the crucible was placed in a 5% hydrogen/argon mixed gas atmosphere at 400° C. for 2 h to obtain a heat-treated PtCo/C catalyst; 50 mg of the heat-treated PtCo/C catalyst was taken and placed in a flask, then 100 mg of urea, 615 μL of oleylamine, 100 mg of cobalt nitrate, and 10 mL of an isopropanol/water (in a volume ratio of 50:50) mixture were added to the flask, and an ultrasonic treatment was conducted for 10 min to obtain a mixed solution; and the mixed solution was placed in a water bath at 25° C. and stirred for 16 h, and then centrifuged (10,000 r.p.m., 5 min) to obtain a precipitate, and the precipitate was collected and vacuum-dried at 60° C. for 6 h to obtain a powder.

S2, The powder was placed in a 5% hydrogen/argon mixed gas atmosphere at 400° C. for 2 h, dispersed in 1 M HCl, heated to 70° C. and kept at this temperature for 2 h, and subjected to suction filtration to obtain a filter cake, and the filter cake was vacuum-dried at 60° C. for 6 h to obtain a carbon-encapsulated PtCo/C catalyst.

In this example, the ligand compound adopted can be replaced by any one selected from the group consisting of formic acid, thiourea, ammonia monohydrate, and ammonium carbonate; the carbonization compound adopted can be replaced by any one selected from the group consisting of malic acid, dopamine, polydopamine, glucose, and sucrose; and the carbonization catalyst adopted can be replaced by any one selected from the group consisting of cobalt chloride, nickel chloride, and nickel nitrate.

### Example 4

S1, A commercial PtCo/C catalyst (Pt content: 28%) was taken and placed in a crucible, and then the crucible was placed in a 5% hydrogen/argon mixed gas atmosphere at 400° C. for 2 h to obtain a heat-treated PtCo/C catalyst; 50 mg of the heat-treated PtCo/C catalyst was taken and placed in a flask, then 50 mg of formic acid, 162.6 mg of dopamine, 20 mg of cobalt chloride, and 10 mL of an isopropanol/water (in a volume ratio of 50:50) mixture were added to the flask, and an ultrasonic treatment was conducted for 10 min to obtain a mixed solution; and the mixed solution was placed in a water bath at 25° C. and stirred for 16 h, and then centrifuged (10,000 r.p.m., 5 min) to obtain a precipitate, and the precipitate was collected and vacuum-dried at 60° C. for 6 h to obtain a powder.

S2, The powder was placed in a 5% hydrogen/argon mixed gas atmosphere at 400° C. for 2 h, dispersed in 1 M HCl, heated to 70° C. and kept at this temperature for 2 h, and subjected to suction filtration to obtain a filter cake, and the filter cake was vacuum-dried at 60° C. for 6 h to obtain a carbon-encapsulated PtCo/C catalyst.

In this example, the ligand compound adopted can be replaced by any one selected from the group consisting of urea, thiourea, ammonia monohydrate, and ammonium carbonate; the carbonization compound adopted can be replaced by any one selected from the group consisting of malic acid, polydopamine, oleylamine, glucose, and sucrose; and the carbonization catalyst adopted can be replaced by any one selected from the group consisting of cobalt nitrate, nickel chloride, and nickel nitrate.

### Example 5

S1, 25 mg of Vulcan XC-72 was dispersed in 100 mL of ethylene glycol, and a first ultrasonic treatment was conducted for 0.5 h to obtain a Vulcan XC-72 solution; 35 mg of Pt(acac)₂ and 7.8 mg of Co(acac)₂ were added to the Vulcan XC-72 solution to obtain a first mixture, and the first mixture was continuously stirred for 12 h until metal ions were thoroughly mixed with Vulcan XC-72 to obtain a second mixture; the second mixture was heated to 180° C. to allow a reaction under reflux for 10 h, then cooled to room temperature, and centrifuged (10,000 r.p.m., 5 min) to obtain a first precipitate; the first precipitate was collected, vacuum-dried at 60° C. for 6 h, then placed in a crucible, kept in a 5% hydrogen/argon mixed gas atmosphere at 400° C. for 2 h, cooled to room temperature, and transferred to a flask; 50 mg of urea, 200 μL of oleylamine, 20 mg of cobalt nitrate, and 10 mL of an isopropanol/water (in a volume ratio of 50:50) mixture were added to the flask, and a second ultrasonic treatment was conducted for 10 min to obtain a mixed solution; and then the mixed solution was placed in a water bath at 25° C. and stirred for 16 h, and then centrifuged (10,000 r.p.m., 5 min) to obtain a second precipitate, and the second precipitate was collected and vacuum-dried at 60° C. for 6 h to obtain a powder.

S2, The powder was placed in a 5% hydrogen/argon mixed gas atmosphere at 400° C. for 2 h, dispersed in 1 M HCl, heated to 70° C. and kept at this temperature for 2 h, and subjected to suction filtration to obtain a filter cake, and the filter cake was vacuum-dried at 60° C. for 6 h to obtain a carbon-encapsulated PtCo/C catalyst.

In this example, the ligand compound adopted can be replaced by any one selected from the group consisting of formic acid, thiourea, ammonia monohydrate, and ammonium carbonate; the carbonization compound adopted can be replaced by any one selected from the group consisting of malic acid, dopamine, polydopamine, glucose, and sucrose; and the carbonization catalyst adopted can be replaced by any one selected from the group consisting of cobalt chloride, nickel chloride, and nickel nitrate.

### Comparative Example 1

50 mg of a commercial PtCo/C catalyst (Pt content: 28%) was taken and placed in a crucible, and then the crucible was placed in a 5% hydrogen/argon mixed gas atmosphere at 400° C. for 2 h to obtain a heat-treated PtCo/C catalyst.

### Comparative Example 2

S1, A commercial PtCo/C catalyst (Pt content: 28%) was taken and placed in a crucible, and then the crucible was placed in a 5% hydrogen/argon mixed gas atmosphere at 700° C. for 2 h to obtain a heat-treated PtCo/C catalyst; 50 mg of the heat-treated PtCo/C catalyst was taken and placed in a flask, then 50 mg of urea, 200 μL of oleylamine, 20 mg of cobalt nitrate, and 10 mL of an isopropanol/water (in a volume ratio of 50:50) mixture were added to the flask, and an ultrasonic treatment was conducted for 10 min to obtain a mixed solution; and the mixed solution was placed in a water bath at 25° C. and stirred for 16 h, and then centrifuged (10,000 r.p.m., 5 min) to obtain a precipitate, and the precipitate was collected and vacuum-dried at 60° C. for 6 h to obtain a powder.

S2, The powder was placed in a 5% hydrogen/argon mixed gas atmosphere at 400° C. for 2 h, dispersed in 1 M HCl, heated to 70° C. and kept at this temperature for 2 h, and subjected to suction filtration to obtain a filter cake, and the filter cake was vacuum-dried at 60° C. for 6 h to obtain a carbon-encapsulated PtCo/C catalyst.

### Comparative Example 3

25 mg of Vulcan XC-72 was dispersed in 100 mL of ethylene glycol, and an ultrasonic treatment was conducted for 0.5 h to obtain a Vulcan XC-72 solution; 35 mg of Pt(acac)₂ and 7.8 mg of Co(acac)₂ were added to the Vulcan XC-72 solution to obtain a first mixture, and the first mixture was continuously stirred for 12 h until metal ions were thoroughly mixed with Vulcan XC-72 to obtain a second mixture; the second mixture was heated to 180° C. to allow a reaction under reflux for 10 h, and then subjected to suction filtration to obtain a filter cake; and the filter cake was dried in an oven at 60° C. for 12 h, then placed in a crucible, and kept in a 5% hydrogen/argon mixed gas atmosphere at 400° C. for 2 h to obtain a heat-treated PtCo/C catalyst.

### Comparative Example 4

S1, 25 mg of Vulcan XC-72 was dispersed in 100 mL of ethylene glycol, and a first ultrasonic treatment was conducted for 0.5 h to obtain a Vulcan XC-72 solution; 35 mg of Pt(acac)₂ and 7.8 mg of Co(acac)₂ were added to the Vulcan XC-72 solution to obtain a first mixture, and the first mixture was continuously stirred for 12 h until metal ions were thoroughly mixed with Vulcan XC-72 to obtain a second mixture; the second mixture was heated to 180° C. to allow a reaction under reflux for 10 h, then cooled to room temperature, and centrifuged (10,000 r.p.m., 5 min) to obtain a first precipitate; the first precipitate was collected, vacuum-dried at 60° C. for 6 h, and then placed in a flask; 50 mg of urea, 200 μL of oleylamine, and 20 mg of cobalt nitrate were added to the flask, and a second ultrasonic treatment was conducted for 10 min to obtain a mixed solution; and then the mixed solution was placed in a water bath at 25° C. and stirred for 16 h, and then centrifuged (10,000 r.p.m., 5 min) to obtain a second precipitate, and the second precipitate was collected and vacuum-dried at 60° C. for 6 h to obtain a powder.

S2, The powder was placed in a 5% hydrogen/argon mixed gas atmosphere at 400° C. for 2 h, dispersed in 1 M HCl, heated to 70° C. and kept at this temperature for 2 h, and subjected to suction filtration to obtain a filter cake, and the filter cake was vacuum-dried at 60° C. for 6 h to obtain a carbon-encapsulated PtCo/C catalyst.

This comparative example was different from Example 5 in that a platinum alloy catalyst without heat treatment was adopted.

### Comparative Example 5

S1, 25 mg of Vulcan XC-72 was dispersed in 100 mL of ethylene glycol, and an ultrasonic treatment was conducted for 0.5 h to obtain a Vulcan XC-72 solution; 35 mg of Pt(acac)₂ and 7.8 mg of Co(acac)₂ were added to the Vulcan XC-72 solution to obtain a first mixture, and the first mixture was continuously stirred for 12 h until metal ions were thoroughly mixed with Vulcan XC-72 to obtain a second mixture; the second mixture was heated to 180° C. to allow a reaction under reflux for 10 h, and then subjected to suction filtration to obtain a filter cake; and the filter cake was dried in an oven at 60° C. for 12 h, then placed in a crucible, and kept in a 5% hydrogen/argon mixed gas atmosphere at 400° C. for 2 h to obtain a heat-treated PtCo/C catalyst.

S2, The heat-treated PtCo/C catalyst was placed in a 5% hydrogen/argon mixed gas atmosphere at 400° C. for 2 h, dispersed in 1 M HCl, heated to 70° C. and kept at this temperature for 2 h, and subjected to suction filtration to obtain a filter cake, and the filter cake was vacuum-dried at 60° C. for 6 h to obtain a carbon-encapsulated PtCo/C catalyst.

This comparative example was different from Example 5 in that PtCo/C was synthesized by a different method without a treatment by urea, oleylamine, and cobalt nitrate.

### Comparative Example 6

S1, 50 mg of a commercial PtCo/C catalyst (Pt content: 28%) without heat treatment was taken and placed in a flask, then 50 mg of urea, 200 μL of oleylamine, 20 mg of cobalt nitrate, and 10 mL of an isopropanol/water (in a volume ratio of 50:50) mixture were added to the flask, and an ultrasonic treatment was conducted for 10 min to obtain a mixed solution; and the mixed solution was placed in a water bath at 25° C. and stirred for 16 h, and then centrifuged (10,000 r.p.m., 5 min) to obtain a precipitate, and the precipitate was collected and vacuum-dried at 60° C. for 6 h to obtain a powder.

S2, The powder was placed in a 5% hydrogen/argon mixed gas atmosphere at 400° C. for 2 h, dispersed in 1 M HCl, heated to 70° C. and kept at this temperature for 2 h, and subjected to suction filtration to obtain a filter cake, and the filter cake was vacuum-dried at 60° C. for 6 h to obtain a carbon-encapsulated PtCo/C catalyst.

This comparative example was different from Example 1 in that a PtCo/C catalyst without heat treatment was adopted.

### Comparative Example 7

S1, 50 mg of a commercial PtCo/C catalyst (Pt content: 28%) was taken and placed in a crucible, and then the crucible was placed in a 5% hydrogen/argon mixed gas atmosphere at 400° C. for 2 h to obtain a heat-treated PtCo/C catalyst.

S2, The heat-treated PtCo/C catalyst was placed in a 5% hydrogen/argon mixed gas atmosphere at 400° C. for 2 h, dispersed in 1 M HCl, heated to 70° C. and kept at this temperature for 2 h, and subjected to suction filtration to obtain a filter cake, and the filter cake was vacuum-dried at 60° C. for 6 h to obtain a carbon-encapsulated PtCo/C catalyst.

This comparative example was different from Example 1 in that the treatment by urea, oleylamine, and cobalt nitrate was not adopted.

### Comparative Example 8

S1, 50 mg of a commercial PtCo/C catalyst (Pt content: 28%) was taken and placed in a crucible, and then the crucible was placed in a nitrogen atmosphere at 400° C. for 2 h to obtain a heat-treated PtCo/C catalyst; 50 mg of the heat-treated PtCo/C catalyst was taken and placed in a flask, then 50 mg of urea, 200 μL of oleylamine, 20 mg of cobalt nitrate, and 10 mL of an isopropanol/water (in a volume ratio of 50:50) mixture were added to the flask, and an ultrasonic treatment was conducted for 10 min to obtain a mixed solution; and the mixed solution was placed in a water bath at 25° C. and stirred for 16 h, and then centrifuged (10,000 r.p.m., 5 min) to obtain a precipitate, and the precipitate was collected and vacuum-dried at 60° C. for 6 h to obtain a powder. S2, The powder was placed in a 5% hydrogen/argon mixed gas atmosphere at 400° C. for 2 h, dispersed in 1 M HCl, heated to 70° C. and kept at this temperature for 2 h, and subjected to suction filtration to obtain a filter cake, and the filter cake was vacuum-dried at 60° C. for 6 h to obtain a carbon-encapsulated PtCo/C catalyst.

### Comparative Example 9

S1, 50 mg of a commercial PtCo/C catalyst (Pt content: 28%) was taken and placed in a crucible, and then the crucible was placed in a 5% hydrogen/argon mixed gas atmosphere at 400° C. for 2 h to obtain a heat-treated PtCo/C catalyst; 50 mg of the heat-treated PtCo/C catalyst was taken and placed in a flask, then 50 mg of urea, 200 μL of oleylamine, 20 mg of cobalt nitrate, and 10 mL of an isopropanol/water (in a volume ratio of 50:50) mixture were added to the flask, and an ultrasonic treatment was conducted for 10 min to obtain a mixed solution; and the mixed solution was placed in a water bath at 25° C. and stirred for 16 h, and then centrifuged (10,000 r.p.m., 5 min) to obtain a precipitate, and the precipitate was collected and vacuum-dried at 60° C. for 6 h to obtain a powder.

S2, The powder was placed in a nitrogen atmosphere at 400° C. for 2 h, dispersed in 1 M HCl, heated to 70° C. and kept at this temperature for 2 h, and subjected to suction filtration to obtain a filter cake, and the filter cake was vacuum-dried at 60° C. for 6 h to obtain a carbon-encapsulated PtCo/C catalyst.

### Comparative Example 10

S1, A commercial PtCo/C catalyst (Pt content: 28%) was taken and placed in a crucible, and then the crucible was placed in a 5% hydrogen/argon mixed gas atmosphere at 400° C. for 2 h to obtain a heat-treated PtCo/C catalyst; 50 mg of the heat-treated PtCo/C catalyst was taken and placed in a flask, then 50 mg of urea, 200 μL of oleylamine, and 10 mL of an isopropanol/water (in a volume ratio of 50:50) mixture were added to the flask, and an ultrasonic treatment was conducted for 10 min to obtain a mixed solution; and the mixed solution was placed in a water bath at 25° C. and stirred for 16 h, and then centrifuged (10,000 r.p.m., 5 min) to obtain a precipitate, and the precipitate was collected and vacuum-dried at 60° C. for 6 h to obtain a powder.

S2, The powder was placed in a 5% hydrogen/argon mixed gas atmosphere at 400° C. for 2 h, dispersed in 1 M HCl, heated to 70° C. and kept at this temperature for 2 h, and subjected to suction filtration to obtain a filter cake, and the filter cake was vacuum-dried at 60° C. for 6 h to obtain a carbon-encapsulated PtCo/C catalyst.

This comparative example was different from Example 1 in that cobalt nitrate was not added.

### Comparative Example 11

S1, 50 mg of a commercial PtCo/C catalyst (Pt content: 28%) was taken and placed in a crucible, and then the crucible was placed in a 20% hydrogen atmosphere at 400° C. for 2 h to obtain a heat-treated PtCo/C catalyst; 50 mg of the heat-treated PtCo/C catalyst was taken and placed in a flask, then 50 mg of urea, 200 μL of oleylamine, 20 mg of cobalt nitrate, and 10 mL of an isopropanol/water (in a volume ratio of 50:50) mixture were added to the flask, and an ultrasonic treatment was conducted for 10 min to obtain a mixed solution; and the mixed solution was placed in a water bath at 25° C. and stirred for 16 h, and then centrifuged (10,000 r.p.m., 5 min) to obtain a precipitate, and the precipitate was collected and vacuum-dried at 60° C. for 6 h to obtain a powder.

S2, The powder was placed in a 20% hydrogen atmosphere at 400° C. for 2 h, dispersed in 1 M HCl, heated to 70° C. and kept at this temperature for 2 h, and subjected to suction filtration to obtain a filter cake, and the filter cake was vacuum-dried at 60° C. for 6 h to obtain a carbon-encapsulated PtCo/C catalyst.

### Comparative Example 12

S1, 50 mg of a commercial PtCo/C catalyst (Pt content: 28%) was taken and placed in a crucible, and then the crucible was placed in a 20% hydrogen atmosphere at 400° C. for 2 h to obtain a heat-treated PtCo/C catalyst; 50 mg of the heat-treated PtCo/C catalyst was taken and placed in a flask, then 50 mg of urea, 200 μL of oleylamine, 20 mg of cobalt nitrate, and 10 mL of an isopropanol/water (in a volume ratio of 50:50) mixture were added to the flask, and an ultrasonic treatment was conducted for 10 min to obtain a mixed solution; and the mixed solution was placed in a water bath at 25° C. and stirred for 16 h, and then centrifuged (10,000 r.p.m., 5 min) to obtain a precipitate, and the precipitate was collected and vacuum-dried at 60° C. for 6 h to obtain a powder.

S2, The powder was placed in a 5% hydrogen/argon mixed gas atmosphere at 400° C. for 2 h, dispersed in 1 M HCl, heated to 70° C. and kept at this temperature for 2 h, and subjected to suction filtration to obtain a filter cake, and the filter cake was vacuum-dried at 60° C. for 6 h to obtain a carbon-encapsulated PtCo/C catalyst.

### Performance Tests

1. Structures of the carbon-encapsulated alloy catalysts prepared in Example 1 and Comparative Examples 1 and 2 each were observed by TEM, and test results were shown in FIG. 1 to FIG. 4.

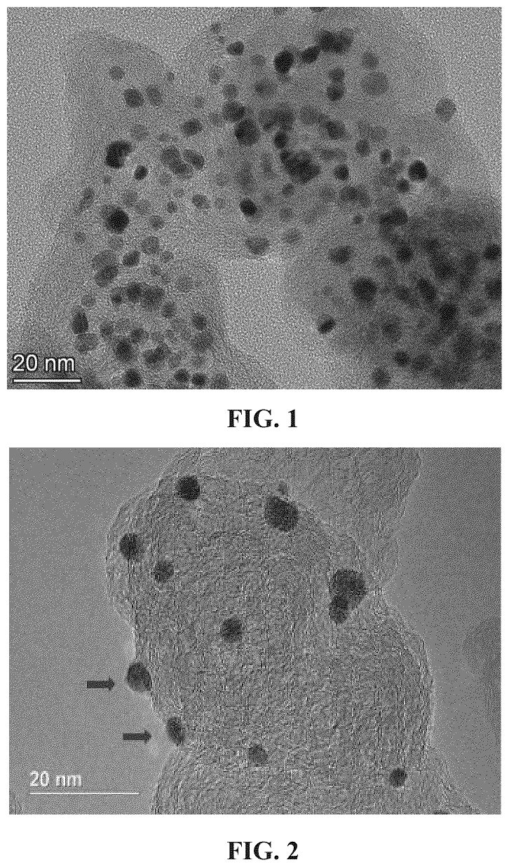

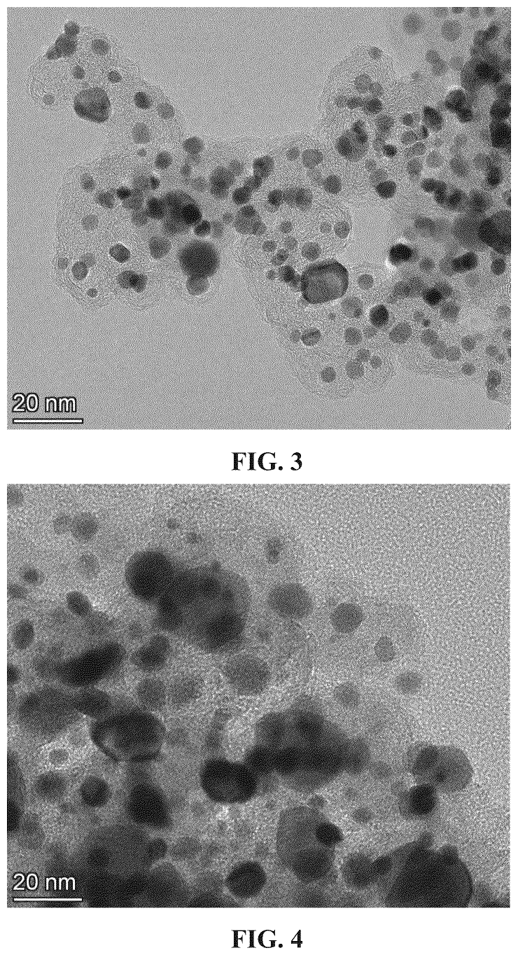

With reference to FIG. 1 to FIG. 4: It can be seen from FIG. 2 that PtCo alloy particles prepared in Example 1 are wrapped by a thin carbon layer. FIG. 3 shows that a morphology and structure of the heat-treated PtCo/C catalyst change slightly in Comparative Example 1; however, in Comparative Example 2, a too-high heat-treatment temperature results in an overall increase in the size of the PtCo/C catalyst, as well as dramatical changes in the morphology and structure of the PtCo/C catalyst, leading to a significant decrease in electrochemical active surface area (ECSA) and mass activity (MA) of the catalyst. Therefore, a heat-treatment temperature for the PtCo/C catalyst should not be too high.

2. The carbon-encapsulated alloy catalysts prepared in the examples and comparative examples each were subjected to an accelerated durability test. A test method was as follows: The catalysts prepared in the examples and comparative examples each were prepared into an ink, and then the ink was spin-dropped on a rotating disk electrode (RDE, GC) to allow ORR performance characterization. Specifically: 1.9 mg of a catalyst, 1.9 mL of deionized water, 10 μL of Nafion (a perfluorosulfonic acid resin)/ethanol solution (5 wt %), and 0.6 mL of isopropanol were taken and added to a sample bottle, mixed, and subjected to ultrasonic dispersion for 30 min to obtain an ink. 16.5 μL of the ink was taken by a pipette, dropped on a GC electrode, and spin-dried at 600 r.p.m. at room temperature. Then, the catalyst was subjected to an ORR test in a three-electrode system, where a Pt mesh was adopted as a counter electrode, an reversible hydrogen electrode (RHE) was adopted as a reference electrode, and RDE was adopted as a working electrode. Nitrogen (N₂) with a purity of 99.999% was introduced into a 0.1 M HClO₄ solution for 30 min to exclude oxygen in the solution. Cyclic voltammetry (CV) scanning was conducted at 0.05 V to 1.2 V vs. RHE with a scanning speed of 50 mV/s to activate a catalyst until a hydrogen adsorption/desorption area peak no longer increased. Then CV scanning was conducted at 0.05 V to 1.2 V vs. RHE with a scanning speed of 20 m V/s for 5 cycles, and a stable CV curve was selected to calculate an ECSA. Oxygen (O₂) was introduced into a 0.1 M HClO₄ solution for 30 min to make the solution saturated with O₂, and linear sweep voltammetry (LSV) was conducted with a scanning range of 0.05 V to 1.05 V vs. RHE, a scanning speed of 10 mV s⁻¹, and a rotating disk rotational speed of 1,600 r.p.m. Then nitrogen was introduced into a system, the same operation was conducted, and a resulting polarization curve was used for background subtraction. MA at 0.9 V was calculated to evaluate a catalytic capacity of a catalyst for ORR.

3. The carbon-encapsulated alloy catalysts prepared in the examples and comparative examples each were subjected to an accelerated durability test. A test method was as follows: The accelerated durability test was conducted at 1,600 r.p.m in an O₂-saturated 0.1 M HClO₄ solution, where cyclic potential scanning was applied in a range of 0.6 V to 1.1 V vs. RHE at a scanning speed of 100 mV/s, and 10,000, 20,000, and 30,000 cycles were conducted. At the end of each cycle, an ECSA (when a CV test was conducted in a new electrolyte saturated with nitrogen, a catalyst must be activated once again: after 50 cycles of CV were conducted in a nitrogen-saturated electrolyte at a scanning speed of 50 mV, an activity was measured) and an activity (LSV under an oxygen-saturated electrolyte) of a catalyst were measured.

4. The catalysts prepared in the examples each were tested for a Pt content. Specifically: 5 mg to 10 mg of a sample was dried in a vacuum drying oven at 80° C. for 12 h, then placed in a test crucible of a thermogravimetric analyzer, weighed, then heated at a heating rate of 2° C./min from room temperature to a final temperature of 800° C. with air or a mixed gas of air and an inert gas in a specified ratio as a working gas of a flow rate of 20 mL/min, and finally cooled to room temperature. Test results were shown in Table 1.

TABLE 1
Thermogravimetric analysis results for samples

| Catalyst type | Residual content (Pt + Co)/% |
|---|---|
| Commercial PtCo/C | 31.2 |
| Example 1 | 30.1 |
| Example 2 | 30.3 |
| Example 3 | 30.9 |
| Example 4 | 30.6 |
| Example 5 | 60.5 |

TABLE 2
Energy-dispersive X-ray spectroscopy (EDS) results for samples

| Catalyst type | C content/% | Pt content/% | O content/% | Co content/% |
|---|---|---|---|---|
| Commercial | 63.15 | 23.83 | 10.87 | 2.15 |
| PtCo/C | | | | |
| Example 1 | 65.62 | 25.34 | 5.89 | 3.15 |
| Comparative | 65.27 | 25.20 | 7.66 | 1.87 |
| Example 1 | | | | |
| Comparative | 61.86 | 29.99 | 4.57 | 3.58 |
| Example 2 | | | | |

TABLE 3
ECSA and MA results of samples after an accelerated durability test

| | | ECSA loss | | MA loss |
|---|---|---|---|---|
| | | rate after | | rate after |
| | ECSA | 30K cycles | MA | 30K cycles |
| Catalyst type | (m² g⁻¹) | of ADT | (A g⁻¹_{Pt}) | of ADT |
| Commercial | 56.62 | 31.01% | 0.44 | 47.42% |
| PtCo/C | | | | |
| Example 1 | 48.47 | 2.63% | 0.37 | 13.32% |
| Example 2 | 49.64 | 2.04% | 0.37 | 15.27% |
| Example 3 | 44.73 | 1.93% | 0.34 | 11.34% |
| Example 4 | 47.94 | 2.57% | 0.37 | 17.15% |
| Example 5 | 49.22 | 5.21% | 0.36 | 14.18% |
| Comparative | 57.58 | 26.93% | 0.45 | 41.46% |
| Example 1 | | | | |
| Comparative | 41.73 | — | 0.29 | — |
| Example 2 | | | | |
| Comparative | 56.43 | 32.98% | 0.42 | 42.78% |
| Example 3 | | | | |
| Comparative | 49.17 | 8.30% | 0.35 | 20.62% |
| Example 4 | | | | |
| Comparative | 58.35 | 30.03% | 0.43 | 39.09% |
| Example 5 | | | | |
| Comparative | 47.75 | 8.13% | 0.36 | 19.92% |
| Example 6 | | | | |
| Comparative | 49.78 | 28.84% | 0.39 | 38.64% |
| Example 7 | | | | |
| Comparative | 46.80 | 9.46% | 0.37 | 23.37% |
| Example 8 | | | | |
| Comparative | 41.70 | 15.60% | 0.33 | 32.78% |
| Example 9 | | | | |
| Comparative | 39.76 | 11.45% | 0.30 | 28.64% |
| Example 10 | | | | |
| Comparative | 38.37 | — | 0.29 | — |
| Example 11 | | | | |
| Comparative | 40.68 | — | 0.31 | — |
| Example 12 | | | | |

It can be seen from the experimental data in Table 1 that a Pt+Co content of a sample in the example of the present disclosure does not change significantly compared with a Pt+Co content of the commercial PtCo/C, indicating that the modification for a catalyst in the present disclosure does not have a great impact on an alloy itself. The modified self-made catalyst in Example 5 has a similar Pt+Co content to a self-made catalyst, which is about 60%.

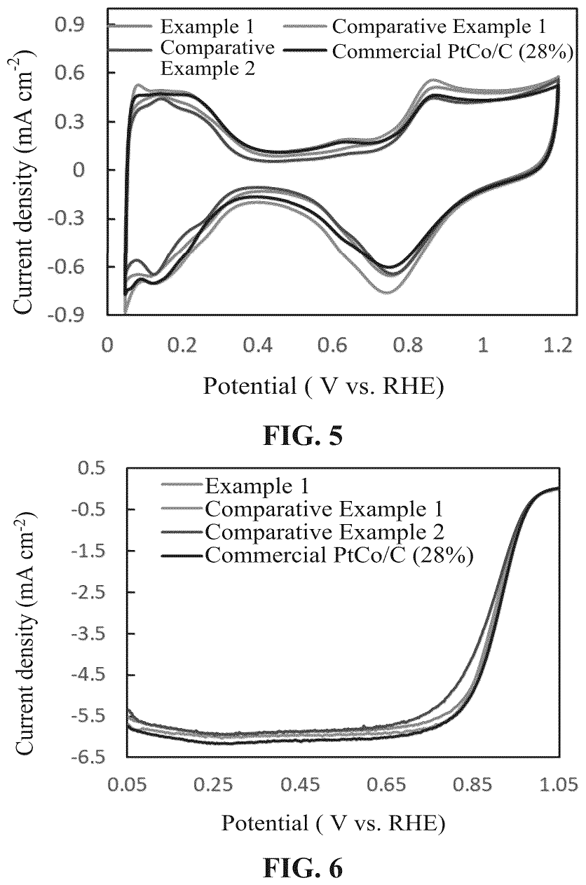

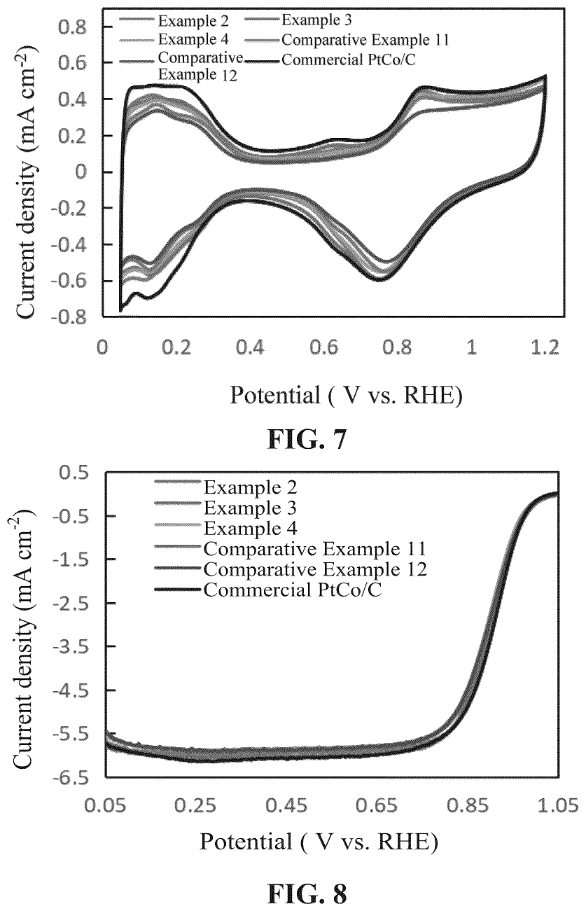

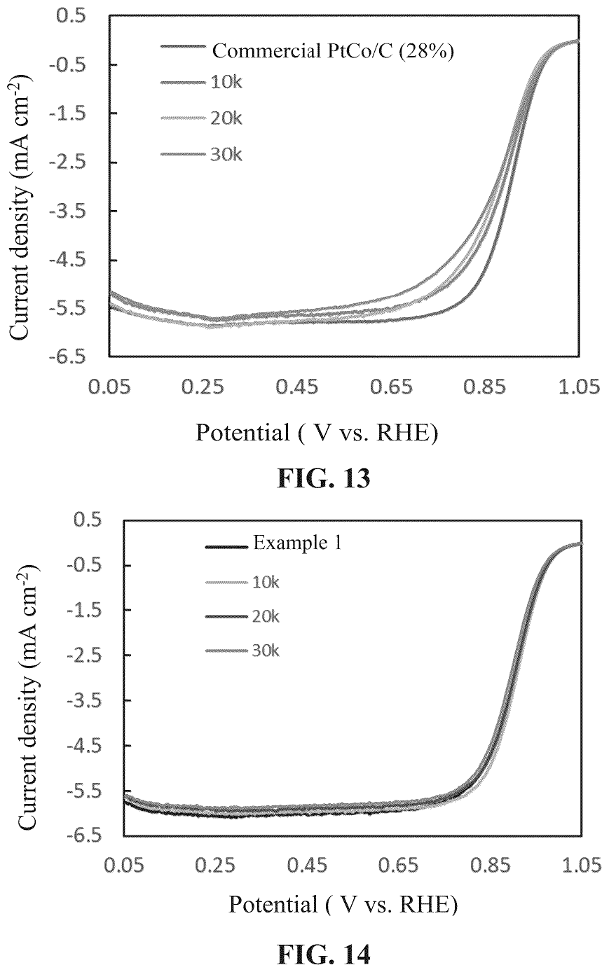

It can be seen from FIG. 5 to FIG. 8 and Table 3 that ECSA loss rates of the modified catalysts in Examples 1 to 5 are less than 15%, and MA loss rates of the modified catalysts are less than 20%. This result indicates that a carbon layer formed by the carbonization compound, the ligand compound, and the carbonization catalyst will block some active sites of a catalyst, thus reducing an ECSA and an MA of the catalyst, but the stability of the catalyst is significantly improved. Specifically, as shown in FIG. 13, FIG. 14, and Table 3, an MA loss rate of the modified PtCo/C catalyst obtained in Example 1 after 30 K cycles of ADT is 13.32% and is 34.10% lower than an MA loss rate of an unmodified PtCo/C catalyst. In particular, an ECSA loss rate of the modified PtCo/C catalyst obtained in Example 1 after 30 K cycles of ADT is merely 2.63%, indicating that a carbon layer formed after modification can effectively protect PtCo alloy particles and delay the dissolution of the alloy particles during working of the catalyst. However, ECSA and MA of the modified catalysts in Comparative Examples 11 and 12 decrease severely, indicating that the structure of an alloy is destroyed due to too-strong reducibility of a gas during a heat treatment.

It can be seen from FIG. 5, FIG. 6, Table 2, and Table 3 that, compared with the modified PtCo/C catalyst in Example 1, ECSA and MA of the catalyst obtained after a heat treatment at 400° C. in a 5% hydrogen/argon mixed gas in Comparative Example 1 remain almost unchanged (almost unchanged compared with commercial PtCo/C), but the stability of the catalyst in Comparative Example 1 is only slightly improved. The stability of the catalyst after the heat treatment in the 5% hydrogen/argon mixed gas is slightly improved compared with the stability of the catalyst before the heat treatment, and the catalyst after the heat treatment has a decreased oxygen content and an increased carbon content according to EDS results; these results indicate that the heat treatment in the reducing gas can effectively improve the defects and oxygen content in a support of the catalyst and increase a graphitization degree of the support, so as to alleviate the carbon corrosion. As can be seen from Energy-dispersive X-ray spectroscopy (EDS) results of Comparative Example 2, the oxygen content decreases significantly and the carbon content increases significantly, but both ECSA and MA decrease significantly; in addition, after the heat treatment, the CV curve of the catalyst changes significantly, and a characteristic peak of hydrogen adsorption/desorption of Pt appears in the CV curve. In combination with the TEM result in FIG. 4, it can be known that a too-high heat-treatment temperature will destroy the structure of an alloy to cause a significant decline in catalytic performance for ORR.

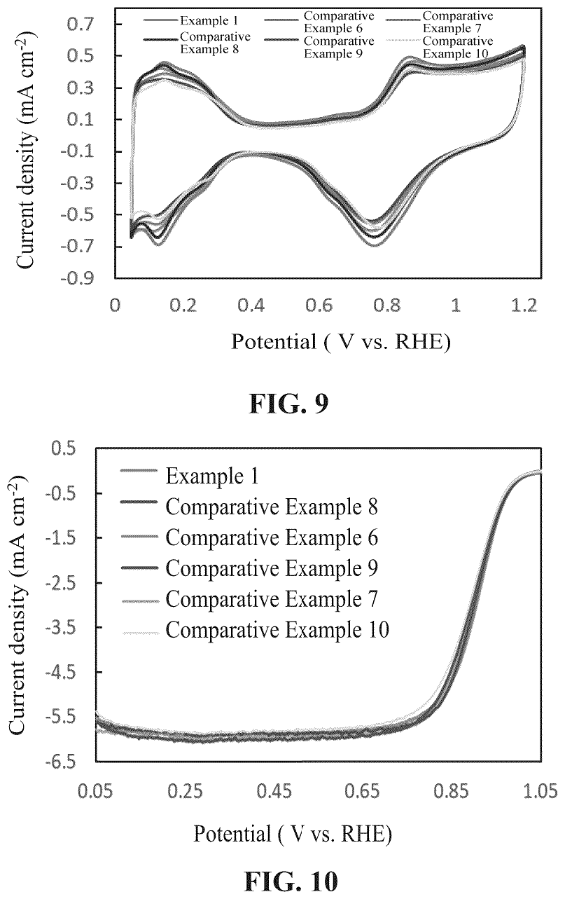

It can be seen from the experimental data in FIG. 9, FIG. 10, and Table 3 that, if a catalyst does not undergo a heat treatment as in Comparative Example 6, a support of the catalyst undergoes significant carbon corrosion during a stability test, resulting in a significant decline in performance of the catalyst. In Comparative Example 7, a carbon layer cannot be formed without the treatment with urea, oleylamine, and cobalt nitrate, and thus ECSA and MA of the catalyst decrease significantly after a stability test. Therefore, a carbon layer formed after the modification in Examples 1 to 5 plays a vital role in the improvement of stability of a PtCo alloy. After the treatments in Comparative Examples 8 and 9, the stability of a catalyst is slightly improved, and an activity of the catalyst decreases largely; this is mainly because nitrogen annealing at medium and high temperatures is not enough to completely carbonize a carbonization compound into a stable carbon layer, and this carbon layer is easily damaged, thereby losing a protective effect for a Pt alloy during a stability test. Results of Comparative Example 10 show that, if the carbonization catalyst is not added during a modification process, a carbon layer formed is unstable, and a large part of the carbon layer will be dissolved and fall off during a stability test. Thus, the catalyst in Comparative Example 10 is less stable than the catalysts in Examples 1 to 5.

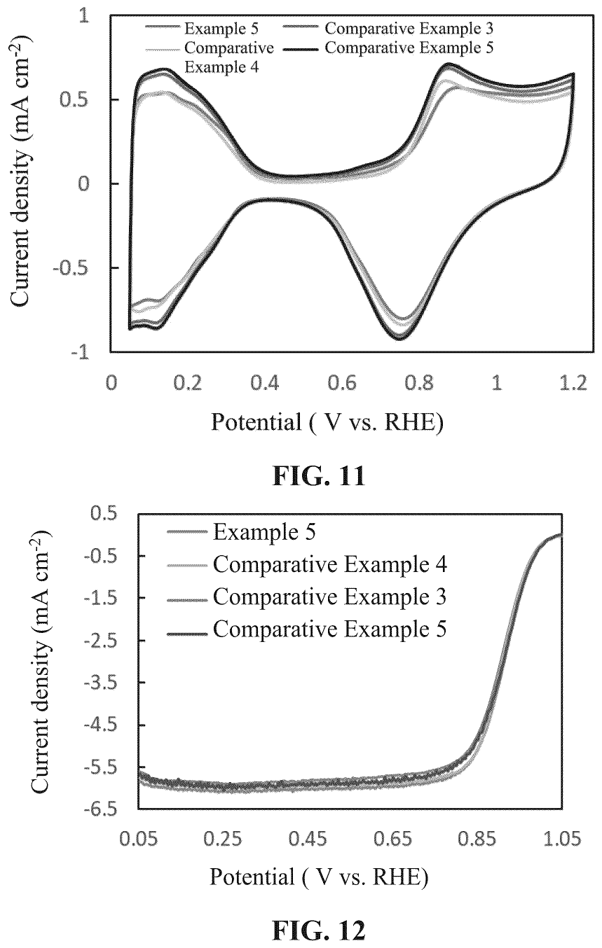

It can be seen from Table 3 and FIG. 11 and FIG. 12 that the carbon layer-encapsulated alloy catalyst with a high graphitization degree and a high load prepared in Example 5 has effectively-improved stability while retaining an excellent activity. Specifically, after 30,000 cycles of accelerated durability testing, ECSA of the catalyst decreases by 5.21%, and MA of the catalyst decreases by 14.18%. After the alloy catalyst prepared in Comparative Example 4 undergoes a stability test, ECSA of the alloy catalyst decreases by 8.30% and MA of the alloy catalyst decreases by 20.62%. This result further indicates that the early heat treatment in a reducing gas can effectively improve the defects and oxygen content in a support of a catalyst, and the subsequent encapsulation of an alloy catalyst with a carbon layer can improve the stability of the catalyst for ORR compared with a Pt alloy catalyst merely encapsulated with a carbon layer. The alloy catalyst is prepared merely with one heat treatment in Comparative Example 3; and the alloy catalyst is prepared without the modification by the ligand compound, the carbonization compound, and the carbonization catalyst in Comparative Example 5. Thus, the catalysts finally produced in Comparative Examples 3 and 5 have significantly-higher ECSA and MA loss rates after 30 K cycles of ADT than the catalyst prepared in Example 5.

In summary, the present disclosure effectively improves the defects and oxygen content in a support of an alloy catalyst through a medium heat-treatment temperature, and then encapsulates the alloy catalyst with a carbon layer at a medium annealing temperature, so as to improve the stability of the alloy catalyst while retaining the alloy properties of the alloy catalyst.

The above examples merely illustrate the principles and effects of the present disclosure, but are not intended to limit the present disclosure. Any person skilled in the art can make modifications or alterations to the above examples without departing from the spirit and scope of the present disclosure. Thus, all equivalent modifications or changes made by those of ordinary skill in the art without departing from the spirit and technical teachings disclosed in the present disclosure should fall within the scope defined by appended claims of the present disclosure.

1. A preparation method of a carbon-encapsulated alloy catalyst, comprising the following steps:
S1, subjecting a catalyst to a heat treatment in a first reducing gas atmosphere to obtain a heat-treated catalyst, mixing the heat-treated catalyst with a carbonization compound, a ligand compound, a carbonization catalyst, and a solvent to obtain a mixture, subjecting the mixture to ultrasonic dispersion and stirring to obtain a first dispersion system, centrifuging the first dispersion system to obtain a precipitate, and drying the precipitate to obtain a powder; and
S2, annealing the powder in a second reducing gas atmosphere to obtain an annealed powder, dispersing the annealed powder in an acid solution to obtain a second dispersion system, subjecting the second dispersion system to heating and suction filtration to obtain a filter cake, and vacuum-drying the filter cake to obtain the carbon-encapsulated alloy catalyst,
wherein the catalyst is a commercial platinum alloy catalyst or a platinum alloy catalyst prepared from a support and a metal precursor.

2. The preparation method of a carbon-encapsulated alloy catalyst according to claim 1, wherein the first reducing gas atmosphere in the S1 and the second reducing gas atmosphere in the S2 comprises at least one selected from the group consisting of a 5% hydrogen/argon mixed gas, a 5% carbon monoxide/helium mixed gas, and a 5% ammonia/nitrogen mixed gas, wherein the content percentage of 5% refers to a volume proportion of a reducing gas in a total gas system.

3. The preparation method of a carbon-encapsulated alloy catalyst according to claim 1, wherein at least one selected from the group consisting of the following (1) to (4) is comprised:
(1) the commercial platinum alloy catalyst comprises at least one selected from the group consisting of PtCo/C, PtCoNi/C, and PtNi/C;
(2) a platinum content in the commercial platinum alloy catalyst is higher than or equal to 20%;
(3) the support comprises at least one selected from the group consisting of acetylene black, carbon black, a carbon nanotube, mesoporous carbon, graphene, a carbon nanowire, and a graphite fiber; and
(4) the metal precursor comprises at least one selected from the group consisting of chloroplatinic acid, platinum chloride, and platinum acetylacetonate.

4. The preparation method of a carbon-encapsulated alloy catalyst according to claim 1, wherein at least one selected from the group consisting of the following (1) to (4) is comprised:
(1) the carbonization compound comprises at least one selected from the group consisting of malic acid, dopamine, polydopamine, oleylamine, glucose, and sucrose;
(2) the ligand compound comprises at least one selected from the group consisting of formic acid, thiourea, ammonia monohydrate, ammonium carbonate, and urea;
(3) the carbonization catalyst comprises at least one selected from the group consisting of cobalt chloride, cobalt nitrate, nickel chloride, and nickel nitrate; and
(4) the solvent in the S1 is an alcohol or an alcohol aqueous solution.

5. The preparation method of a carbon-encapsulated alloy catalyst according to claim 1, wherein the heat-treated commercial platinum alloy catalyst, the carbonization compound, the ligand compound, and the carbonization catalyst are in a mass ratio of 1: (1-10): (0.2-2): (0.1-1).

6. The preparation method of a carbon-encapsulated alloy catalyst according to claim 1, wherein the metal precursor, the support, the carbonization compound, the ligand compound, and the carbonization catalyst are in a mass ratio of 1:(0.5-1): (0.8-8): (0.17-17): (0.09-0.9).

7. The preparation method of a carbon-encapsulated alloy catalyst according to claim 1, wherein at least one selected from the group consisting of the following (1) to (3) is comprised:
(1) the heat treatment in the S1 is conducted at 200° C. to 400° C. for 1 h to 2 h;
(2) the ultrasonic dispersion in the S1 is conducted for 10 min to 30 min; and
(3) the stirring in the S1 is conducted for 12 h to 24 h.

8. The preparation method of a carbon-encapsulated alloy catalyst according to claim 1, wherein at least one selected from the group consisting of the following (1) to (4) is comprised:
(1) the annealing in the S2 is conducted at 400° C. to 500° C. for 2 h to 4 h;
(2) a concentration of the acid solution in the S2 is 1 M to 1.5 M;
(3) the heating in the S2 is as follows: heating the second dispersion system to a temperature of 70° C. to 80° C., and holding the temperature for 2 h to 12 h; and
(4) the vacuum-drying in the S2 is conducted at 60° C. for 4 h to 6 h.

9. A carbon-encapsulated alloy catalyst prepared by the preparation method of a carbon-encapsulated alloy catalyst according to claim 1.

10. A fuel cell comprising the carbon-encapsulated alloy catalyst according to claim 9.

11. A carbon-encapsulated alloy catalyst prepared by the preparation method of a carbon-encapsulated alloy catalyst according to claim 2.

12. A carbon-encapsulated alloy catalyst prepared by the preparation method of a carbon-encapsulated alloy catalyst according to claim 3.

13. A carbon-encapsulated alloy catalyst prepared by the preparation method of a carbon-encapsulated alloy catalyst according to claim 4.

14. A carbon-encapsulated alloy catalyst prepared by the preparation method of a carbon-encapsulated alloy catalyst according to claim 5.

15. A carbon-encapsulated alloy catalyst prepared by the preparation method of a carbon-encapsulated alloy catalyst according to claim 6.

16. A fuel cell comprising the carbon-encapsulated alloy catalyst according to claim 11.

17. A fuel cell comprising the carbon-encapsulated alloy catalyst according to claim 12.

18. A fuel cell comprising the carbon-encapsulated alloy catalyst according to claim 13.

19. A fuel cell comprising the carbon-encapsulated alloy catalyst according to claim 14.

20. A fuel cell comprising the carbon-encapsulated alloy catalyst according to claim 15.
